(19) United States
(12) Patent Application Publication
(10) Pub. No.: US 2024/0401290 A1
(43) Pub. Date: Dec. 5, 2024

(54) INTELLIGENT GARDEN ROBOT WITH MULTIFUNCTIONAL MODULES

(71) Applicant: SHENZHEN HANYANG TECHNOLOGY CO., LTD., Shenzhen (CN)

(72) Inventor: Yang HUANG, Shenzhen (CN)

(73) Assignee: SHENZHEN HANYANG TECHNOLOGY CO., LTD., Shenzhen (CN)

(21) Appl. No.: 18/807,006

(22) Filed: Aug. 16, 2024

Related U.S. Application Data
(63) Continuation of application No. PCT/US2022/041270, filed on Aug. 23, 2022.

(51) Int. Cl. E01H 5/09; A01D 34/00; A01D 34/66; A01D 101/00; A01G 20/47

(52) U.S. Cl. CPC E01H 5/098; A01D 34/008; A01D 34/66; A01G 20/47; A01D 2101/00

(57) ABSTRACT

Provided is an intelligent garden robot with multifunctional modules. By providing functional components that are driven by a driving device to automatically carry out snow sweeping, mowing or leaf blowing, users can connect different functional components to traveling component when they need to carry out snow sweeping, mowing or leaf blowing, and can replace the functional components on the traveling component at any time. The functions of snow sweeping, mowing and leaf blowing are integrated into the intelligent garden robot with multifunctional modules. During the actual application process, the functional modules are driven along the cleaning path by the traveling components, and the snow sweeping, mowing and leaf blowing operations can be automatically completed according to user's needs, replacing the traditional method of manual cleaning. The applicability of the intelligent garden robot with multifunctional modules is improved while improving the efficiency of garden cleaning and reducing labor costs.

### CROSS-REFERENCE TO RELATED APPLICATIONS

This application is a continuation of International Application No. PCT/US2022/041270, filed on Aug. 23, 2022, which is incorporated by reference in its entirety.

### TECHNICAL FIELD

The present disclosure relates to the technical field of cleaning equipment, and in particular to an intelligent garden robot with multifunctional modules.

### BACKGROUND

Places adjacent to green vegetation such as courtyards are prone to weeds and fallen leaves. In winter, snow will block the road. If they are not cleaned in time, daily activities and travel will be affected.

### SUMMARY

An embodiment of the present disclosure provides an intelligent garden robot with multifunctional modules, including:
a first connection portion; and
a traveling component connected to the first connection portion, the traveling component being configured to travel in a traveling direction under driving of a power unit; wherein
the intelligent garden robot with multifunctional modules further includes at least one or more of a snow sweeping component, a mowing component, and a leaf blowing component;
the snow sweeping component includes a first snow shovel, a first driving device and a second connection portion, the first snow shovel is movably connected to the second connection portion, the first driving device is connected to the first snow shovel, the first driving device is configured to drive the first snow shovel to reciprocate to cut a snow layer, the first snow shovel is configured to throw the cut snow layer to a collection area along a first direction, and the second connection portion is detachably connected to the first connection portion;
the mowing component includes a cutting edge, a second driving device and a third connection portion, the cutting edge is movably connected to the third connection portion;
the second driving device is connected to the cutting edge, the second driving device is configured to drive the cutting edge to reciprocate for mowing, and the third connection portion is detachably connected to the first connection portion; and
the leaf blowing component includes a fan and a fourth connection portion connected to the fan, the fan has an air outlet channel for performing leaf blowing operations, and the fourth connection portion is detachably connected to the first connection portion.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1 is an exploded schematic structural view of an intelligent garden robot with multifunctional modules according to an embodiment of the present disclosure.

FIG. 2 is a schematic structural view of a traveling component of the intelligent garden robot with multifunctional modules according to an embodiment of the present disclosure.

FIG. 3 is a schematic structural view of a snow sweeping component of the intelligent garden robot with multifunctional modules according to an embodiment of the present disclosure.

FIG. 4 is an exploded schematic structural view of the snow sweeping component of the intelligent garden robot with multifunctional modules according to an embodiment of the present disclosure from a first perspective.

FIG. 5 is an exploded schematic structural view of the snow sweeping component of the intelligent garden robot with multifunctional modules according to an embodiment of the present disclosure from a second perspective.

FIG. 6 is a schematic structural view of a mowing component of the intelligent garden robot with multifunctional modules according to an embodiment of the present disclosure.

FIG. 7 is a schematic structural view of a leaf blowing component of the intelligent garden robot with multifunctional modules according to an embodiment of the present disclosure from a first perspective.

FIG. 8 is a schematic structural view of the leaf blowing component of the intelligent garden robot with multifunctional modules according to an embodiment of the present disclosure from a second perspective.

### DETAILED DESCRIPTION OF THE EMBODIMENTS

Nowadays, the cleaning work of courtyards and other places mostly relies on manual methods, which is inefficient and requires a lot of labor costs.

The main objective of the present disclosure is to provide an intelligent garden robot with multifunctional modules, which aims to solve the technical problems of low efficiency and high labor cost for cleaning places such as courtyards by manual methods.

The present disclosure provides an intelligent garden robot with multifunctional modules. By providing functional components (snow sweeping component, mowing component and leaf blowing component, respectively) that are driven by a driving device to automatically carry out snow sweeping, lawn mowing or leaf blowing operations, users can connect different functional components to the traveling component when they need to carry out snow sweeping, lawn mowing or leaf blowing operations, and can replace the functional components on the traveling component at any time. In this way, the functions of snow sweeping, lawn mowing and leaf blowing are integrated into the intelligent garden robot with multifunctional modules. During the actual application process, the corresponding functional modules are driven along the cleaning path by the traveling components, and the snow sweeping, lawn mowing and leaf blowing operations can be automatically completed according to the user's needs, replacing the traditional method of manual cleaning. The applicability of the intelligent garden robot with multifunctional modules is improved while improving the efficiency of garden cleaning and reducing labor costs.

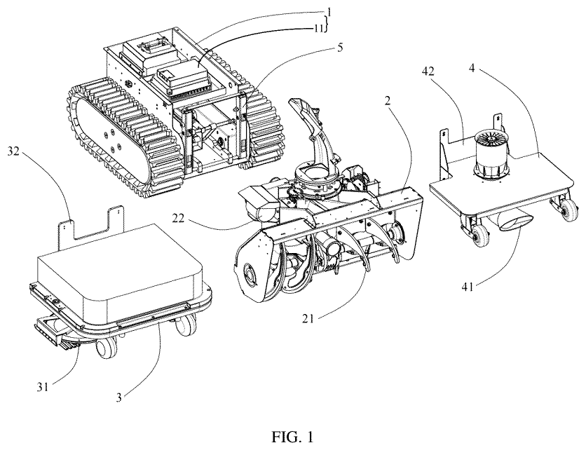

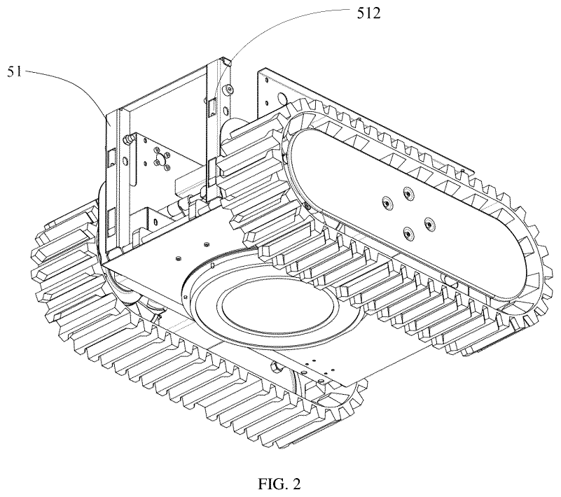

The present disclosure provides an intelligent garden robot with multifunctional modules. As shown in FIG. 1 to FIG. 8, the intelligent garden robot with multifunctional modules includes a first connection portion 5 and a traveling component 1 connected to the first connection portion 5. The traveling component 1 is configured to travel in a traveling direction under driving of a power unit.

The intelligent garden robot with multifunctional modules further includes at least one or more of a snow sweeping component 2, a mowing component 3, and a leaf blowing component 4.

The snow sweeping component 2 includes a first snow shovel 21, a first driving device 22 and a second connection portion 26. The first snow shovel 21 is movably connected to the second connection portion 26. The first driving device 22 is connected to the first snow shovel 21. The first driving device 22 is configured to drive the first snow shovel 21 to reciprocate to cut a snow layer. The first snow shovel 21 is configured to throw the cut snow layer to a collection area 27 along a first direction. The second connection portion 26 is detachably connected to the first connection portion 5.

The mowing component 3 includes a cutting edge 31, a second driving device 35 and a third connection portion 32, the cutting edge 31 is movably connected to the third connection portion 32. The second driving device 35 is connected to the cutting edge 31, and the second driving device 35 is configured to drive the cutting edge 31 to reciprocate for mowing; the third connection portion 32 is detachably connected to the first connection portion 5.

The leaf blowing component 4 includes a fan 41 and a fourth connection portion 42. The fan 41 is connected to the fourth connection portion 42. The fan 41 has an air outlet channel 412 for performing leaf blowing operations. The fourth connection portion 42 is detachably connected to the first connection portion 5.

In this embodiment, the traveling component 1 can be moved by traveling wheels or tracks driven by a power unit. The power unit can be driven by converting energy such as electrical energy and thermal energy into mechanical energy. The controller and memory can be provided in the traveling component 1, and the traveling path and obstacle avoidance algorithm can be preset in the memory for the controller to invoke. After invoking the preset traveling path and obstacle avoidance algorithm in the memory, the controller can make the traveling component 1 automatically travel along the cleaning path by controlling the start and stop timing of the power unit. The steering operation of the traveling component 1 can be realized by the differential speed of the traveling wheels on both sides or the tracks on both sides.

The first driving device 22 can include a motor and other devices for providing power and a supporting transmission mechanism (such as a reducer, a worm gear device, a crank-rocker mechanism, a cam component, etc.), to make the first snow shovel 21 reciprocate. The reciprocating motion can be circular motion, reciprocating swing, reciprocating linear motion or combinations thereof. The first snow shovel 21 can be in an arc shape, and the tail end thereof has a blade. When the above-mentioned reciprocating motion is in the stage of moving along the direction of the snow layer to be cut, the blade portion is configured to cut the snow layer accumulated in blocks under the force provided by the first driving device 22. When the above-mentioned reciprocating motion is in the stage of moving along the direction of the collection area 27, the first snow shovel 21 can use the arc-shaped structure to shovel a part of the cut snow layer and throw the snow to the collection area 27 for recovery under the force provided by the first driving device 22. The collection area 27 can be an accommodating compartment provided in the snow sweeping component 2 or the traveling component 1, or can be a working area for secondary transfer of the part of the thrown snow. In practical applications, it is only necessary to transfer the cut snow layer to the effect that it no longer hinders the path that the intelligent garden robot with multifunctional modules has traveled, which is not limited herein.

The second driving device 35 can include a motor and other devices for providing power and a supporting transmission mechanism (such as a reducer, a worm gear device, a crank-rocker mechanism, a cam component, etc.), to make the cutting edge 31 reciprocate. The reciprocating motion can be circular motion, reciprocating swing, reciprocating linear motion and combinations thereof. There is one cutting edge 31 or there are a plurality of spaced apart cutting edges 31. The blade portion of the cutting edge 31 can continuously cut the weeds on the sweeping path with the above-mentioned reciprocating motion.

The fan 41 is configured to blow the fallen leaves on the cleaning path (i.e., the fallen leaves in the target leaf blowing area) to other areas through wind power.

The first connection portion 5 can be fixed to the second connection portion 26, the third connection portion 32, and the fourth connection portion 42 by means of snap-connection or plug-in connection in which the protrusion cooperates with the concave cavity, and by means of other connecting devices, such as threaded fastener connection, pin connection, etc. During the actual application, the user can respectively connect different functional components (the snow sweeping component 2, the mowing component 3, and the leaf blowing component 4) to the traveling component 1 when snow sweeping, lawn mowing, and leaf blowing operations are required, and can replace the functional components on the traveling component 1 at any time. In this way, the functions of snow sweeping, mowing and leaf blowing are integrated into the intelligent garden robot with multifunctional modules, so that the intelligent garden robot with multifunctional modules can automatically perform snow sweeping, mowing and leaf blowing operations according to user needs, which replaces the traditional method of manual cleaning, improves the efficiency of courtyard cleaning, reduces labor costs, and improves the applicability of the intelligent garden robot with multifunctional modules.

It should be noted that except for the snow sweeping component 2, the mowing component 3, and the leaf blowing component 4, the intelligent garden robot with multifunctional modules can also include other functional components. Other functional components can also be detachably connected to the traveling component 1 according to user needs, to further expand the functions of the intelligent garden robot with multifunctional modules. Other functional components can refer to the snow sweeping component 2, the mowing component 3 and the leaf blowing component 4, which is detachably connected to the first connection portion 5 by means of snap-connection or plug-in connection, threaded fastener connection, pin-shaft connection in which the protrusion cooperates with the concave cavity, and can be replaced at any time as needed.

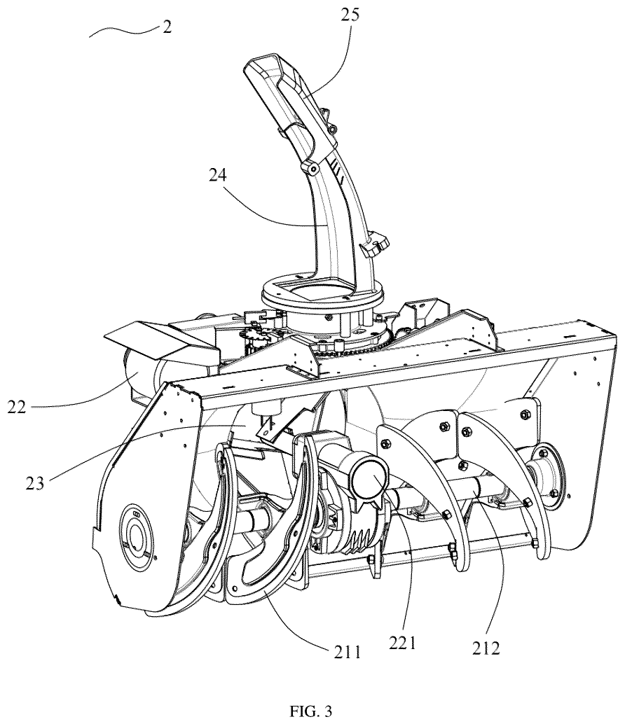

Further, as shown in FIG. 3 to FIG. 5, in an exemplary embodiment, the snow sweeping component 2 further includes a second snow shovel 23 connected to the first driving device 22. The first driving device 22 is configured to drive the second snow shovel 23 to reciprocate, to receive the snow layer thrown by the first snow shovel 21 along the first direction and throw the snow layer to a target snow throwing area along a second direction.

The first driving device 22 can be arranged in two groups. One group of the first driving devices 22 is configured to drive the first snow shovel 21, and the other group of the first driving devices 22 is configured to drive the second snow shovel 23. The first driving device 22 can include a motor and other devices for providing power and a supporting transmission mechanism (such as a reducer, a worm gear device, a crank-rocker mechanism, a cam component, etc.), to make the second snow shovel 23 reciprocate. The reciprocating motion can be circular motion, reciprocating swing, reciprocating linear motion and combinations thereof. The second snow shovel 23 can continuously transfer the snow layer thrown by the first snow shovel 21 to the target snow throwing area by means of pushing and throwing under the power provided by the first driving device 22 with the above reciprocating movement. The target snow throwing area can be located outside the intelligent garden robot with multifunctional modules. The second snow shovel 23 can perform a secondary transfer of the snow layer, which is more convenient to control the transfer path of the snow layer cut by the first snow shovel 21.

Further, as shown in FIG. 3 to FIG. 5, in an exemplary embodiment, the first snow shovel 21 includes a rotating shaft 212 and a first shovel portion 211. The first shovel portion 211 is spirally provided on the rotating shaft 212. The rotating shaft 212 is rotatably connected to the second connection portion 26. An axial direction of the rotating shaft 212 is perpendicular to the traveling direction. The first driving device 22 is connected to the rotating shaft 212. The first driving device 22 is configured to drive the rotating shaft 212 to rotate, to drive the first shovel portion 211 to rotate and cut the snow layer. The first shovel portion 211 is configured to throw the cut snow layer to the collection area 27 along the first direction. The first direction is away from the traveling direction.

The first shovel portion 211 has multiple helical turns. The blade of the first shovel portion 211 is provided on a side away from the rotating shaft 212, and multiple cutting positions can be formed in the horizontal direction (i.e., the axial direction of the rotating shaft 212), to improve the cutting efficiency. The first shovel portion 211 can use the spiral structure to receive a part of the cut snow layer, and with the rotation of the rotating shaft 212, the part of the snow layer can be thrown backward (i.e., toward a direction opposite to the traveling direction) to the collection area 27 through centrifugal action.

Further, as shown in FIG. 3 to FIG. 5, in an exemplary embodiment, the second snow shovel 23 includes a snow sweeping turntable 231 and a plurality of second shovel portions 232. The second shovel portions 232 are provided along a circumference of the snow sweeping turntable 231. The first driving device 22 is connected to the snow sweeping turntable 231. The first driving device 22 is configured to drive the snow sweeping turntable 231 to rotate, to drive the second shovel portion 232 to receive the snow layer thrown by the first shovel portion 211 along the first direction and throw the snow layer to the target snow throwing area along the second direction.

The second shovel portions 232 are spaced apart along the circumferential direction of the snow sweeping turntable 231. The second shovel portion 232 can receive the snow layer thrown by the first shovel portion 211. With the rotation of the snow sweeping turntable 231, the part of the snow layer is thrown to the target snow throwing area (which can be the exterior of the intelligent garden robot with multifunctional modules) by centrifugal action in a direction away from the center of the snow sweeping turntable 231, to realize the secondary transfer of the snow layer.

Further, as shown in FIG. 3 to FIG. 5, in an exemplary embodiment, an axial direction of the snow sweeping turntable 231 is perpendicular to the axial direction of the rotating shaft 212. The snow sweeping turntable 231 has a first end surface facing the first direction. The second shovel portion 232 is provided on the first end surface. The first driving device 22 includes a first rotary motor 222 and a worm gear component 221. The first rotary motor 222 is connected to the snow sweeping turntable 231. The first rotary motor 222 is connected to a worm gear of the rotating shaft through the worm gear component 221. The first rotary motor 222 is configured to simultaneously drive the snow sweeping turntable 231 and the rotating shaft 212 to rotate.

In this embodiment, the first driving device 22 can simultaneously drive the first snow shovel 21 and the second snow shovel 23 through a device that provides power (the first rotary motor 222). Therefore, the synergy between the actions of the first snow shovel 21 and the second snow shovel 23 is improved while the material cost is saved.

Further, as shown in FIG. 3 to FIG. 5, in an exemplary embodiment, the snow sweeping component 2 further includes a guide channel 24. One end of the guide channel 24 faces the second snow shovel 23, and the other end of the guide channel 24 extends along the second direction.

In this embodiment, the guide channel 24 is configured to guide the throwing direction of the snow layer after the secondary transfer by the second snow shovel 23, and the snow layer can be thrown to the target snow throwing area more accurately. The guide channel 24 can be a pipe or a baffle as shown in FIG. 3. In practical applications, it only needs to play the role of guiding the throwing direction of the snow layer through the blocking effect, which is not limited herein.

Further, as shown in FIG. 3 to FIG. 5, in an exemplary embodiment, one end of the guide channel 24 is vertical. Another end of the guide channel 24 is extending upward from a direction horizontally away from one end of the guide channel 24. The snow sweeping component 2 further includes a third driving device 28 connected to one end of the guide channel 24. The third driving device 28 is configured to drive another end of the guide channel 24 to rotate around one end of the guide channel 24.

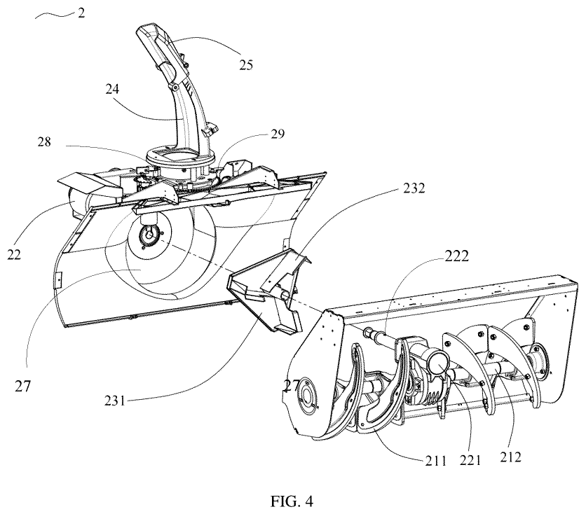

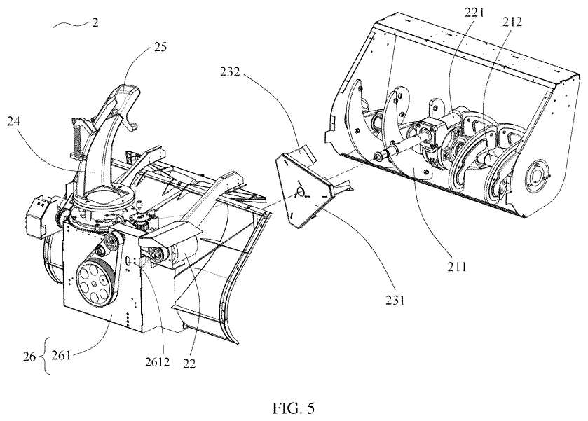

In this embodiment, when the snow sweeping turntable 231 is vertical as shown in FIG. 4 and FIG. 5, the snow layer will be thrown upward by the second shovel portion 232 under the centrifugal action of the rotation of the snow sweeping turntable 231 and enter the guide channel 24 from the lower end of the guide channel 24. Since the upper end of the guide channel 24 deviates from the lower end of the guide channel 24 in the horizontal direction, the snow layer entering the guide channel 24 will be thrown out from the upper end of the guide channel 24 in a parabolic direction away from the guide channel 24 horizontally. When the third driving device 28 drives the guide channel 24 to rotate, the upper end of the guide channel 24 can be rotated relative to the lower end of the vertical guide channel 24. Therefore, the throwing angle of the snow layer on the horizontal plane can be easily adjusted as required. The third driving device 28 may include a rotary motor and a corresponding transmission mechanism.

It can be understood that the third driving device 28 can be electrically connected to the controller, and the snow sweeping path and the snow sweeping strategy algorithm can be preset in the memory. When the controller calls the snow sweeping path and the snow sweeping strategy algorithm in the memory, corresponding control signals can be sent to the third driving device 28, to automatically adjust the snow throwing angle on the horizontal plane by controlling the rotation angle of the guide channel 24.

Further, as shown in FIG. 3 to FIG. 5, in an exemplary embodiment, the snow sweeping component 2 further includes a snow shield 25 rotatably connected to another end of the guide channel 24 along a horizontal direction. The snow sweeping component 2 further includes a fourth driving device 29 connected to the snow shield 25. The fourth driving device 29 is configured to drive the snow shield 25 to rotate relative to the guide channel 24, to adjust a throwing angle of the snow layer thrown from another end of the guide channel 24 in a vertical direction.

In this embodiment, when the snow layer entering the guide channel 24 is thrown from the upper end of the guide channel 24 in a parabolic direction away from the guide channel 24 horizontally, the blocking effect of the snow shield 25 can limit the throwing angle of the snow layer in the vertical direction. The snow shield 25 provided at the position shown in FIG. 3 to FIG. 5 is taken as an example. The smaller the angle between the snow shield 25 and the ground, the smaller the angle at which the snow layer is thrown from the upper end of the guide channel 24 (the angle between the tangential direction of the throwing direction and the ground). The fourth driving device 29 drives the snow shield 25 to rotate, and the throwing angle of the snow layer in the vertical direction can be conveniently adjusted as required. The fourth driving device 29 can include a rotary motor and a corresponding transmission mechanism.

It can be understood that the fourth driving device 29 can be electrically connected to the controller, and the snow sweeping path and the snow sweeping strategy algorithm can be preset in the memory. When the controller calls the snow sweeping path and the snow sweeping strategy algorithm in the memory, corresponding control signals can be sent to the fourth driving device 29, to automatically adjust the snow throwing angle in the vertical direction by controlling the rotation angle of the snow shield 25.

Further, in an exemplary embodiment, the snow sweeping component 2 further includes a first distance sensing device (not shown) electrically connected to the first driving device 22. The first distance sensing device is configured to detect a thickness of the snow layer on a ground. The first distance sensing device is configured to send a snow sweeping signal to the first driving device 22 when the thickness of the snow layer exceeds a first thickness threshold, and the first driving device 22 is configured to drive the first snow shovel 21 to reciprocate when receiving the snow sweeping signal.

The first distance sensing device can be a photoelectric distance sensor, the first distance sensing device can be electrically connected to the first driving device 22 through the controller, and the controller can send a corresponding start signal to the first driving device 22 according to the snow sweeping signal fed back by the first distance sensing device, to automatically control the timing of the snow sweeping operation of the snow sweeping component 2. It can be understood that the first distance sensing device can also be electrically connected to the power unit, the third driving device 28, the fourth driving device 29 of the traveling component 1 through the controller, the controller can automatically control the movements of the traveling component 1, the guide channel 24 and the snow shield 25 based on the detection result of the first distance sensing device, to improve the automation and intelligence of the intelligent garden robot with multifunctional modules.

Further, in an exemplary embodiment, the snow sweeping component 2 further includes a first weather sensing device (not shown) electrically connected to the first driving device 22. The first weather sensing device is configured to obtain a weather condition. The first weather sensing device is configured to send a snow sweeping signal to the first driving device 22 when the weather condition meets a first preset condition, and the first driving device 22 is configured to drive the first snow shovel 21 to reciprocate when receiving the snow sweeping signal.

In this embodiment, the first preset condition can include various indicators representing snowfall through different dimensions. For example, whether the duration of snowfall exceeds the preset time threshold, whether the number of times the duration of snowfall exceeds the preset time threshold exceeds the preset number of times within a preset time period, the probability of snowfall in a preset time period in the future, or the like. In this way, the intelligent garden robot with multifunctional modules can autonomously carry out snow sweeping operations in advance according to weather conditions, avoiding the inconvenience of snow sweeping operations when the snow layer is too thick.

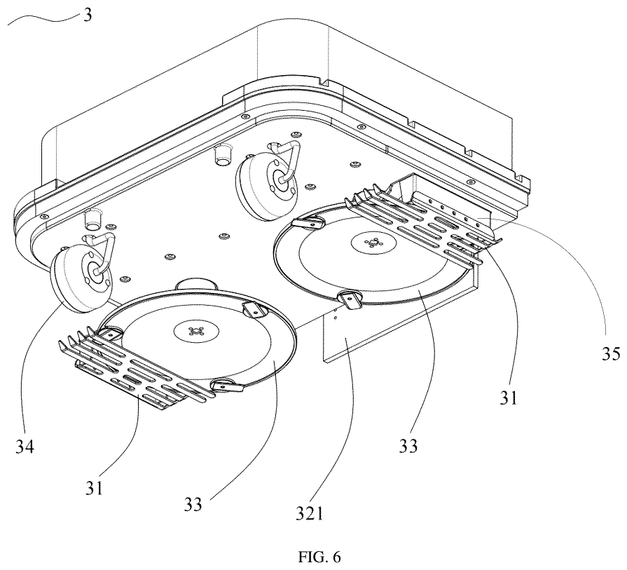

Further, as shown in FIG. 6, in an exemplary embodiment, the mowing component 3 further includes a mowing turntable 33 rotatably connected to the third connection portion 32. The mowing turntable 33 has a second end surface towards a ground. The cutting edge 31 is provided on the second end surface along a circumferential direction, and the second driving device 35 is connected to the mowing turntable 33. The second driving device 35 is configured to drive the mowing turntable 33 to rotate, to drive the cutting edge 31 for mowing.

In this embodiment, a plurality of cutting edges 31 can be provided along the circumferential direction of the mowing turntable 33, the mowing turntable 33 is driven to rotate by the second driving device 35, to improve the mowing efficiency. The second driving device 35 can include a rotary motor and a corresponding transmission mechanism.

Further, as shown in FIG. 6, in an exemplary embodiment, there are two spaced apart mowing turntables 33.

When there are two mowing turntables 33 as shown in the figure, the mowing efficiency can be further improved.

Further, in an exemplary embodiment, the mowing component 3 further includes a second distance sensing device (not shown) electrically connected to the second driving device 35. The second distance sensing device is configured to detect a weed height on a ground. The second distance sensing device is configured to send a mowing signal to the second driving device 35 when the weed height exceeds a first height threshold, and the second driving device 35 is configured to drive the cutting edge 31 to reciprocate for mowing when receiving the mowing signal.

The second distance sensing device can be a photoelectric distance sensor, and the second distance sensing device can be electrically connected to the second driving device 35 through the controller. The controller can send a corresponding start signal to the second driving device 35 according to the mowing signal fed back by the second distance sensing device, to automatically control the timing of the mowing component 3 for mowing. It can be understood that the second distance sensing device can also be electrically connected to the power unit of the traveling component 1 through the controller, and the controller can automatically control the traveling action of the traveling component 1 based on the detection result of the second distance sensing device, to improve the automation and intelligence of the intelligent garden robot with multifunctional modules.

Further, in an exemplary embodiment, the mowing component 3 further includes a recording module (not shown) for storing a preset growth period, and the recording module is electrically connected to the second driving device 35. The recording module is configured to record a current mowing date when the second driving device 35 drives the cutting edge 31 for mowing. The recording module is configured to send a mowing signal to the second driving device 35 when the preset growth period has been experienced since the current mowing date, and the second driving device 35 is configured to drive the cutting edge 31 to reciprocate for mowing again when receiving the mowing signal.

In this embodiment, the recording module can be electrically connected to the second driving device 35 through the controller, and the controller can send a corresponding start signal to the second driving device 35 according to the mowing signal fed back by the recording module, to automatically control the timing of the mowing component 3 for mowing. In this way, the mowing operation can be automatically performed according to the growth cycle of the weeds, which improves the automation and intelligence of the intelligent garden robot with multifunctional modules. It can be understood that the recording module can also be electrically connected to the power unit of the traveling component 1 through the controller, and the controller can automatically control the traveling action of the traveling component 1 based on the growth cycle of the weeds.

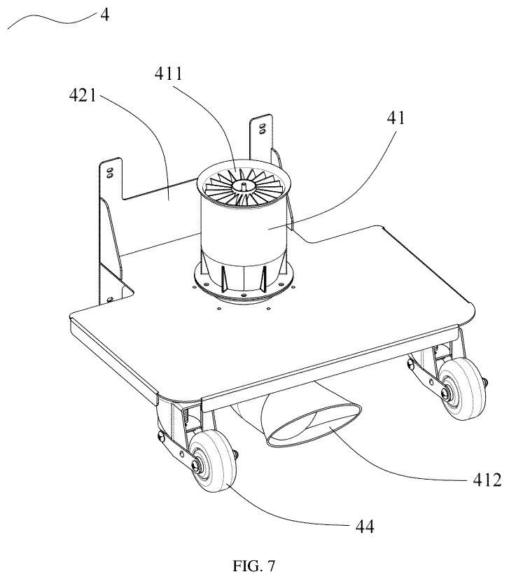

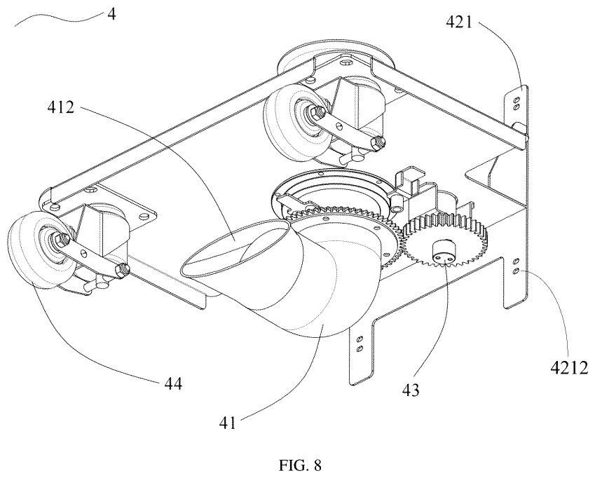

Further, as shown in FIG. 7 and FIG. 8, in an exemplary embodiment, the leaf blowing component 4 further includes a fifth driving device 43 connected to the fan 41, and the fifth driving device 43 is configured to drive the fan 41 to rotate, to adjust a direction of the air outlet channel 412.

The leaf blowing component 4 can include a flat plate, and the fan 41 is in the shape of a bent tube. One end of the air inlet channel 411 of the fan 41 is vertical and rotatably connected to the flat plate. One end of the air outlet channel 412 of the fan 41 is horizontal or in an oblique downward direction to face the target leaf blowing area on the ground. The fifth driving device 43 drives the fan 41 to rotate, and one end of the air outlet channel 412 of the fan 41 can rotate relative to one end of the air inlet channel 411 of the fan 41 (i.e., rotate around the vertical axis). In this way, the leaf blowing angle of the fan 41 can be easily adjusted, and the leaf blowing operation for the fallen leaves in different areas is more convenient.

Further, as shown in FIG. 1 to FIG. 8, in an exemplary embodiment, the first connection portion 5 includes a vertical first connection component 51 connected to the traveling component 1, and the first connection component 51 is provided with a first connection through hole 512. The second connection portion 26 includes a vertical second connection component 261, the first snow shovel 21 is movably connected to the second connection component 261, and the second connection component 261 is provided with a second connection through hole 2612. The first connection through hole 512 and the second connection through hole 2612 are configured to pass a pin shaft to fix the first connection component 51 relative to the second connection component 261. One of the first connection component 51 and the second connection component 261 is a connection plate, and another of the first connection component 51 and the second connection component 261 is a connection square tube.

The illustrated specific embodiment is taken as an example. The second connection component 261 is a vertical connection plate welded on the chassis of the snow sweeping component 2. The four corners of the connection plate are provided with a second connection through hole 2612, and the first connection component 51 is two vertical square tubes spaced apart. Four first connection through holes 512 are provided at corresponding positions on the vertical square tubes. During the installation process, the second connection component 261 is attached to the first connection component 51 and the second connection through hole 2612 is aligned with the first connection through hole 512. Then, the four pins are respectively inserted into each group of the first connection through holes 512 and the second connection through holes 2612, so that the quick connection between the snow sweeping component 2 and the traveling component 1 is realized. When the installed snow blowing component 2 needs to be disassembled, the first connection component 51 and the second connection component 261 can be separated by simply pulling out the pin.

Further, as shown in FIG. 1 to FIG. 8, in an exemplary embodiment, the first connection portion 5 includes a vertical first connection component 51 connected to the traveling component 1, and the first connection component 51 is provided with a first connection through hole 512. The third connection portion 32 includes a vertical third connection component 321, the cutting edge 31 is movably connected to the third connection component 321, and the third connection component 321 is provided with a third connection through hole. The first connection through hole 512 and the third connection through hole are configured to pass a pin shaft, to fix the first connection component 51 relative to the third connection component 321. One of the first connection component 51 and the third connection component 321 is a connection plate, and another of the first connection component 51 and the third connection component 321 is a connection square tube.

The specific embodiment shown in the figures is taken as an example. The third connection component 321 is a vertical connection plate welded on the chassis of the mowing component 3. The four corners of the connection plate are provided with a third connection through hole, and the first connection component 51 is two vertical square tubes spaced apart. Four first connection through holes 512 are provided at corresponding positions on the vertical square tubes. During the installation process, the third connection component 321 is attached to the first connection component 51 and the third connection through hole is aligned with the first connection through hole 512. Then, the four pins are respectively inserted into each group of the first connection through holes 512 and the third connection through holes, so that the quick connection between the mowing component 3 and the traveling component 1 is realized. When the installed mowing component 3 needs to be disassembled, the first connection component 51 and the third connection component 321 can be separated by simply pulling out the pin.

A first universal wheel 34 can be provided on the chassis of the mowing component 3, and the mowing component 3 can be driven to move by the traveling component 1.

Further, as shown in FIG. 1 to FIG. 8, in an exemplary embodiment, the first connection portion 5 includes a vertical first connection component 51 connected to the traveling component 1, and the first connection component 51 is provided with a first connection through hole 512. The fourth connection portion 42 includes a vertical fourth connection component 421, the fan 41 is connected to the fourth connection component 421, and the fourth connection component 421 is provided with a fourth connection through hole 4212. The first connection through hole 512 and the fourth connection through hole 4212 are configured to pass a pin shaft, to fix the first connection component 51 relative to the fourth connection component 421. One of the first connection component 51 and the fourth connection component 421 is a connection plate, and another of the first connection component 51 and the fourth connection component 421 is a connection square tube.

The illustrated specific embodiment is taken as an example. The fourth connection component 421 is a vertical connection plate welded on the chassis of the leaf blowing component 4. The four corners of the connection plate are provided with a fourth connection through hole 4212, and the first connection component 51 is two vertical square tubes spaced apart. Four first connection through holes 512 are provided at corresponding positions on the vertical square tubes. During the installation process, the fourth connection component 421 is attached to the first connection component 51 and the fourth connection through hole 4212 is aligned with the first connection through hole 512. Then, the four pins are respectively inserted into each group of the first connection through holes 512 and the fourth connection through holes 4212, so that the quick connection between the leaf blowing component 4 and the traveling component 1 is realized. When the installed leaf blowing component 4 needs to be disassembled, the first connection component 51 and the fourth connection component 421 can be separated by simply pulling out the pin.

A second universal wheel 44 can be provided on the chassis of the leaf blowing component 4, and the leaf blowing component 4 can be driven to move by the traveling component 1.

Further, in an exemplary embodiment, the traveling component 1 includes a power detection module 11, and the power detection module 11 is configured to issue a charging prompt signal when power of the traveling component 1 is lower than a preset power threshold.

In this embodiment, the recharge path and the related path algorithm can be preset in the memory. The power detection module 11 can be electrically connected to the controller. When the controller receives the charging prompt signal sent by the power detection module 11, the controller can call the recharge path and the related path algorithm in the memory to control the intelligent garden robot with multifunctional modules to automatically return to the charging area for charging (wireless charging can be used). After charging, the controller recalls the snow sweeping, mowing or leaf blowing algorithms and corresponding travel paths in the memory to return to the original clearing area to continue snow sweeping, mowing or leaf blowing operations. Therefore, the normal progress of cleaning work can be avoided due to power failure, and the cleaning efficiency of the intelligent garden robot with multifunctional modules is further improved.

Besides, the charging prompt signal sent by the power detection module 11 may also be an alarm signal in the form of prompt sound, text, image, etc., to remind the user to perform the charging operation by manual means.

It should be noted that if there is a directional indication (such as up, down, left, right, front, rear . . . ) in the embodiments of the present disclosure, the directional indication is only used to explain the relative positional relationship, movement, etc. of the components in a certain posture (as shown in the drawings). If the specific posture changes, the directional indication will change accordingly.

It should be noted that, the descriptions associated with, e.g., “first” and “second,” in the present disclosure are merely for descriptive purposes, and cannot be understood as indicating or suggesting relative importance or impliedly indicating the number of the indicated technical feature. Therefore, the feature associated with “first” or “second” can expressly or impliedly include at least one such feature. Besides, the meaning of “and/or” appearing in the disclosure includes three parallel scenarios. For example, “A and/or B” includes only A, or only B, or both A and B. In addition, the technical solutions between the various embodiments can be combined with each other, but they must be based on the realization of those of ordinary skill in the art. When the combination of technical solutions is contradictory or cannot be achieved, it should be considered that such a combination of technical solutions does not exist, nor is it within the scope of the present disclosure.

Based on the disclosure and teaching of the above specification, those skilled in the art to which the present disclosure pertains can also make changes and modifications to the above embodiments. Therefore, the present disclosure is not limited to the specific embodiments disclosed and described above, and some modifications and changes to the present disclosure should also fall within the scope of the claims of the present disclosure. In addition, although some specific terms are used in this specification, these terms are only for the convenience of description and do not constitute any limitation to the present disclosure.

What is claimed is:

1. An intelligent garden robot with multifunctional modules, comprising:
a first connection portion; and
a traveling component connected to the first connection portion, the traveling component being configured to travel in a traveling direction;
wherein:
the intelligent garden robot with multifunctional modules further comprises at least one or more of a snow sweeping component, a mowing component, and a leaf blowing component;
the snow sweeping component comprises a first snow shovel, a first driving device and a second connection portion, the first snow shovel is movably connected to the second connection portion, the first driving device is connected to the first snow shovel, the first driving device is configured to drive the first snow shovel to reciprocate to cut a snow layer, the first snow shovel is configured to throw the cut snow layer to a collection area along a first direction, and the second connection portion is detachably connected to the first connection portion;
the mowing component comprises a cutting edge, a second driving device and a third connection portion, the cutting edge is movably connected to the third connection portion;
the second driving device is connected to the cutting edge, the second driving device is configured to drive the cutting edge to reciprocate for mowing, and the third connection portion is detachably connected to the first connection portion; and
the leaf blowing component comprises a fan and a fourth connection portion connected to the fan, the fan has an air outlet channel for performing leaf blowing operations, and the fourth connection portion is detachably connected to the first connection portion.

2. The intelligent garden robot with multifunctional modules of claim 1, wherein the snow sweeping component further comprises a second snow shovel connected to the first driving device, and the first driving device is configured to drive the second snow shovel to reciprocate, to receive the snow layer thrown by the first snow shovel along the first direction and throw the snow layer to a target snow throwing area along a second direction.

3. The intelligent garden robot with multifunctional modules of claim 2, wherein the first snow shovel comprises a rotating shaft and a first shovel portion, the first shovel portion is spirally provided on the rotating shaft, the rotating shaft is rotatably connected to the second connection portion, an axial direction of the rotating shaft is perpendicular to the traveling direction, the first driving device is connected to the rotating shaft, the first driving device is configured to drive the rotating shaft to rotate, to drive the first shovel portion to rotate and cut the snow layer, the first shovel portion is configured to throw the cut snow layer to the collection area along the first direction, and the first direction is away from the traveling direction.

4. The intelligent garden robot with multifunctional modules of claim 3, wherein the second snow shovel comprises a snow sweeping turntable and a plurality of second shovel portions, the second shovel portions are provided along a circumference of the snow sweeping turntable, the first driving device is connected to the snow sweeping turntable, and the first driving device is configured to drive the snow sweeping turntable to rotate, to drive the second shovel portion to receive the snow layer thrown by the first shovel portion along the first direction and throw the snow layer to the target snow throwing area along the second direction.

5. The intelligent garden robot with multifunctional modules of claim 4, wherein an axial direction of the snow sweeping turntable is perpendicular to the axial direction of the rotating shaft, the snow sweeping turntable has a first end surface facing the first direction, and the second shovel portion is provided on the first end surface, the first driving device comprises a first rotary motor and a worm gear component, the first rotary motor is connected to the snow sweeping turntable, the first rotary motor is connected to a worm gear of the rotating shaft through the worm gear component, and the first rotary motor is configured to simultaneously drive the snow sweeping turntable and the rotating shaft to rotate.

6. The intelligent garden robot with multifunctional modules of claim 2, wherein the snow sweeping component further comprises a guide channel, one end of the guide channel faces the second snow shovel, and another end of the guide channel is extended along the second direction.

7. The intelligent garden robot with multifunctional modules of claim 6, wherein one end of the guide channel is vertical, another end of the guide channel is extended upward from a direction horizontally away from one end of the guide channel, the snow sweeping component further comprises a third driving device connected to one end of the guide channel, and the third driving device is configured to drive another end of the guide channel to rotate around one end of the guide channel.

8. The intelligent garden robot with multifunctional modules of claim 7, wherein the snow sweeping component further comprises a snow shield rotatably connected to another end of the guide channel along a horizontal direction, the snow sweeping component further comprises a fourth driving device connected to the snow shield, and the fourth driving device is configured to drive the snow shield to rotate relative to the guide channel, to adjust a throwing angle of the snow layer thrown from another end of the guide channel in a vertical direction.

9. The intelligent garden robot with multifunctional modules of claim 1, wherein the snow sweeping component further comprises a first distance sensing device electrically connected to the first driving device, the first distance sensing device is configured to detect a thickness of the snow layer on a ground and send a snow sweeping signal to the first driving device when the thickness of the snow layer exceeds a first thickness threshold, and the first driving device is configured to drive the first snow shovel to reciprocate upon receiving the snow sweeping signal.

10. The intelligent garden robot with multifunctional modules of claim 1, wherein the snow sweeping component further comprises a first weather sensing device electrically connected to the first driving device, the first weather sensing device is configured to obtain a weather condition and send a snow sweeping signal to the first driving device when the weather condition meets a first preset condition, and the first driving device is configured to drive the first snow shovel to reciprocate upon receiving the snow sweeping signal.

11. The intelligent garden robot with multifunctional modules of claim 1, wherein the mowing component further comprises a mowing turntable rotatably connected to the third connection portion, the mowing turntable has a second end surface towards a ground, the cutting edge is provided on the second end surface along a circumferential direction, the second driving device is connected to the mowing turntable, and the second driving device is configured to drive the mowing turntable to rotate, to drive the cutting edge for mowing.

12. The intelligent garden robot with multifunctional modules of claim 11, wherein the mowing component comprises two spaced apart mowing turntables.

13. The intelligent garden robot with multifunctional modules of claim 1, wherein the mowing component further comprises a second distance sensing device electrically connected to the second driving device, the second distance sensing device is configured to detect a weed height on a ground and send a mowing signal to the second driving device when the weed height exceeds a first height threshold, and the second driving device is configured to drive the cutting edge to reciprocate for mowing upon receiving the mowing signal.

14. The intelligent garden robot with multifunctional modules of claim 1, wherein the mowing component further comprises a recording module for storing a preset growth period, the recording module is electrically connected to the second driving device; the recording module is configured to record a current mowing date that the second driving device drives the cutting edge for mowing, the recording module is further configured to send a mowing signal to the second driving device when the preset growth period beginning from the current mowing date is ended, and the second driving device is configured to drive the cutting edge to reciprocate for mowing again upon receiving the mowing signal.

15. The intelligent garden robot with multifunctional modules of claim 1, wherein the leaf blowing component further comprises a fifth driving device connected to the fan, and the fifth driving device is configured to drive the fan to rotate, to adjust a direction of the air outlet channel.

16. The intelligent garden robot with multifunctional modules of claim 1, wherein:
the first connection portion comprises a vertical first connection component connected to the traveling component, and the first connection component is provided with a first connection through hole;
the second connection portion comprises a vertical second connection component, the first snow shovel is movably connected to the second connection component, and the second connection component is provided with a second connection through hole;
the first connection through hole and the second connection through hole are configured to pass a pin shaft to fix the first connection component relative to the second connection component; and
one of the first connection component and the second connection component is a connection plate, and another of the first connection component and the second connection component is a connection square tube.

17. The intelligent garden robot with multifunctional modules of claim 1, wherein:
the first connection portion comprises a vertical first connection component connected to the traveling component, and the first connection component is provided with a first connection through hole;
the third connection portion comprises a vertical third connection component, the cutting edge is movably connected to the third connection component, and the third connection component is provided with a third connection through hole;
the first connection through hole and the third connection through hole are configured to pass a pin shaft to fix the first connection component relative to the third connection component; and
one of the first connection component and the third connection component is a connection plate, and another of the first connection component and the third connection component is a connection square tube.

18. The intelligent garden robot with multifunctional modules of claim 1, wherein:
the first connection portion comprises a vertical first connection component connected to the traveling component, and the first connection component is provided with a first connection through hole;
the fourth connection portion comprises a vertical fourth connection component, the fan is connected to the fourth connection component, and the fourth connection component is provided with a fourth connection through hole;
the first connection through hole and the fourth connection through hole are configured to pass a pin shaft to fix the first connection component relative to the fourth connection component; and
one of the first connection component and the fourth connection component is a connection plate, and another of the first connection component and the fourth connection component is a connection square tube.

19. The intelligent garden robot with multifunctional modules of claim 1, wherein the traveling component comprises a power detection module, and the power detection module is configured to issue a charging prompt signal when a power of the traveling component is lower than a preset power threshold.

20. An intelligent garden robot with multifunctional modules, comprising:
a first connection portion; and
a traveling component connected to the first connection portion, the traveling component being configured to travel in a traveling direction;
wherein:
the intelligent garden robot with multifunctional modules further comprises a snow sweeping component;
the snow sweeping component comprises a first snow shovel, a first driving device and a second connection portion, the first snow shovel is movably connected to the second connection portion, the first driving device is connected to the first snow shovel, the first driving device is configured to drive the first snow shovel to reciprocate to cut a snow layer, the first snow shovel is configured to throw the cut snow layer to a collection area along a first direction, and the second connection portion is detachably connected to the first connection portion; and
the snow sweeping component further comprises a second snow shovel connected to the first driving device, and the first driving device is configured to drive the second snow shovel to reciprocate, to receive the snow layer thrown by the first snow shovel along the first direction and throw the snow layer to a target snow throwing area along a second direction.
